(19) United States
(12) Patent Application Publication
(10) Pub. No.: US 2009/0070796 A1
(43) Pub. Date: Mar. 12, 2009

(54) Method And System For Back Channel Communication Utilizing DTMF For Set Top Box Devices

(76) Inventors: Ilya Stomakhin, Cupertino, CA (US); Ayman Ghobrial, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 12/027,829

(22) Filed: Feb. 7, 2008

Related U.S. Application Data
(60) Provisional application No. 60/971,287, filed on Sep. 11, 2007.

(51) Int. Cl. H04N 7/16; H04N 7/173; H04N 7/20

(52) U.S. Cl. 725/1; 725/121; 725/106; 725/70

(57) ABSTRACT

Data may be encoded into dual tone multiple frequency (DTMF) digits within a set top box (STB). The STB may be a satellite STB. The STB may establish connection to a networked entity such as a billing center or satellite headend via voice call over cellular network and communicate data encoded by DTMF digits. A wireless transceiver integrated within the STB and/or an external wireless transceiver such as cellular phone may be utilized to establish a call and transmit the DTMF digits. The external wireless transceiver may be coupled to the STB via a wired connection or a wireless connection such as WiFi or Bluetooth. The data communicated via DTMF digits may comprise billing data. The STB may receive an acknowledgement for receipt of the transmitted data.

### CROSS-REFERENCE TO RELATED APPLICATIONS/INCORPORATION BY REFERENCE

This application makes reference to, claims priority to, and claims the benefit of U.S. Provisional Application Ser. No. 60/971287 (Attorney Docket No. 18875US01), filed on Sep. 11, 2007, which is hereby incorporated herein by reference in its entirety.

### FIELD OF THE INVENTION

Certain embodiments of the invention relate to set top box communication. More specifically, certain embodiments of the invention relate to a method and system for back channel communication utilizing DTMF for set top box devices.

### BACKGROUND OF THE INVENTION

Consumers may utilize set top boxes to receive multimedia content from a service provider via cable or via wireless satellite transmissions. The received multimedia content may be processed within the set top box (STB) and sent to an audio/video display for viewing or sent to a storage device for example. Service providers that rely on satellite communications for delivery of multimedia content may transmit data on a forward link from the service provider to the consumer. However, the satellite service provider may not receive data back from the consumer via the same wireless satellite communications path and may require an alternative means for communication. A communications path directed from the consumer to the service provider may be referred to as the reverse link or a “back channel”. A back channel may be utilized to communicate operational or service related data such as pay-per-view and may comprise a forward and reverse link. For example, current satellite television STBs rely on landline connections to communicate billing and other record keeping data to and from a satellite TV service provider's billing center. This communication link is called a back channel. Current satellite STBs use analog modems over landlines for back channel communications.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and system for back channel communication utilizing DTMF for set top box devices, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary communication system comprising a satellite set top box (STB) enabled to engage in DTMF digit back channel communication, in accordance with an embodiment of the invention.

FIG. 1B is a block diagram of an exemplary STB enabled to communicate DTMF digits to networked entities via an integrated Bluetooth transceiver and a cellular phone, in accordance with an embodiment of the invention.

FIG. 1C is a block diagram of an exemplary STB enabled to communicate DTMF digits via an integrated cellular transceiver, in accordance with an embodiment of the invention.

FIG. 2A is a block diagram of an exemplary back channel portion of an STB configured to transmit DTMF digits via an integrated wireless transceiver, in accordance with an embodiment of the invention.

FIG. 2B is a block diagram of an exemplary back channel portion of an STB configured to transmit DTMF digits via a wireless transceiver plug-in card, in accordance with an embodiment of the invention.

FIG. 3A is a flow chart illustrating exemplary steps for utilizing DTMF digits for STB communication with networked entities, in accordance with an embodiment of the invention.

FIG. 3B is a flow chart illustrating exemplary steps for utilizing DTMF digits for STB communication with networked entities from the perspective of a server 158 that may be located within a satellite service provider billing center, in accordance with an embodiment of the invention.

### DETAILED DESCRIPTION OF THE INVENTION

Certain aspects of the invention may be found in a method and system for back channel communication utilizing DTMF for set top box (STB) devices. The back channel communication may convey data via dual tone multiple frequency digits between an STB and one or more networked entities and/or services via wireless and/or line communication paths. (For illustrative purposes, throughout this document, DTMF digits may refer to the digits, characters and symbols utilized in DTMF communication which may comprise 0, 1, 2, 3, 4, 5, 6, 7, 8, 9, A, B, C, D, * and #, for example.) The networked entities and/or networked services may comprise, for example and without limitation, a satellite service provider's headend and/or a billing center. The DTMF digits may be generated within the STB based on a sequence of bits. The STB device may utilize one or more of a plurality of integrated wireless transceivers to transmit the DTMF digits via a wireless network to the networked entity or service. For example, a wireless personal area network (WPAN) such as Bluetooth, a wireless local area network (WLAN), Zigbee, ultra low power (ULP), cellular and/or infrared (IR) link may be utilized to transfer the DTMF digits via one or more network links such as the Internet. In addition, a cable connection, for example, a USB cable may be connected between the STB and a cellular phone to enable the STB backchannel. The generated DTMF digits may be converted to analog tones and vice versa according to the technology transporting and/or terminating the DTMF digit communication. Acknowledgement of receipt of DTMF digits from the networked entity or service may be received by the STB. The DTMF digits may be utilized for a plurality of applications, for example, billing purposes, such as for pay-per-view and/or location/timing data such as GPS data.

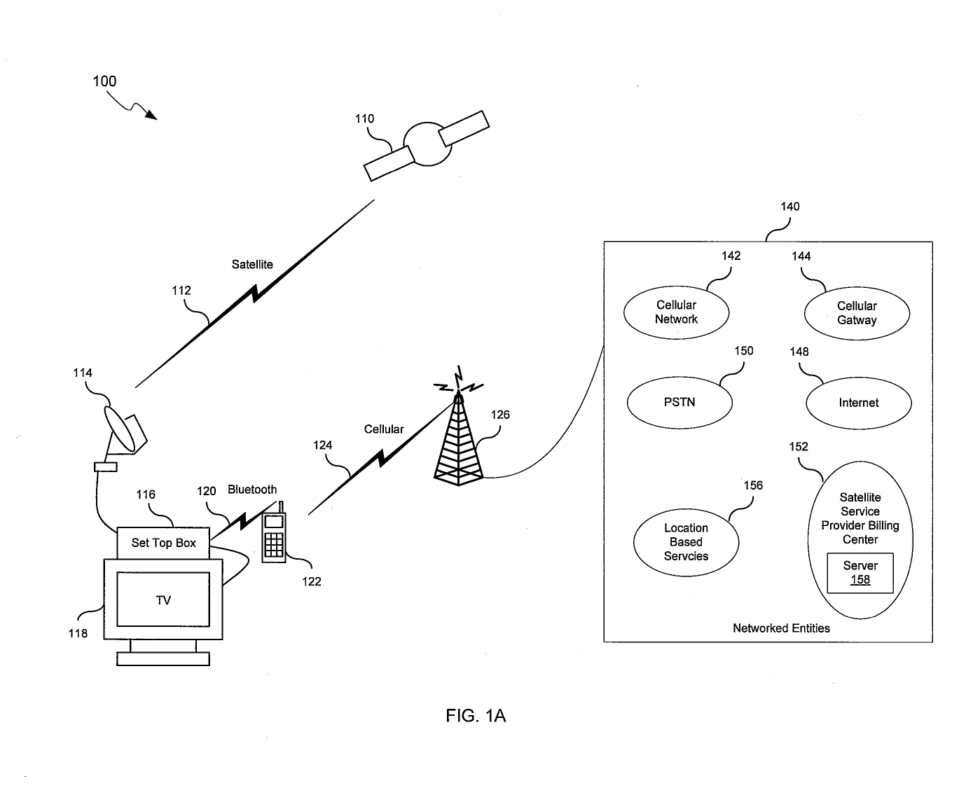

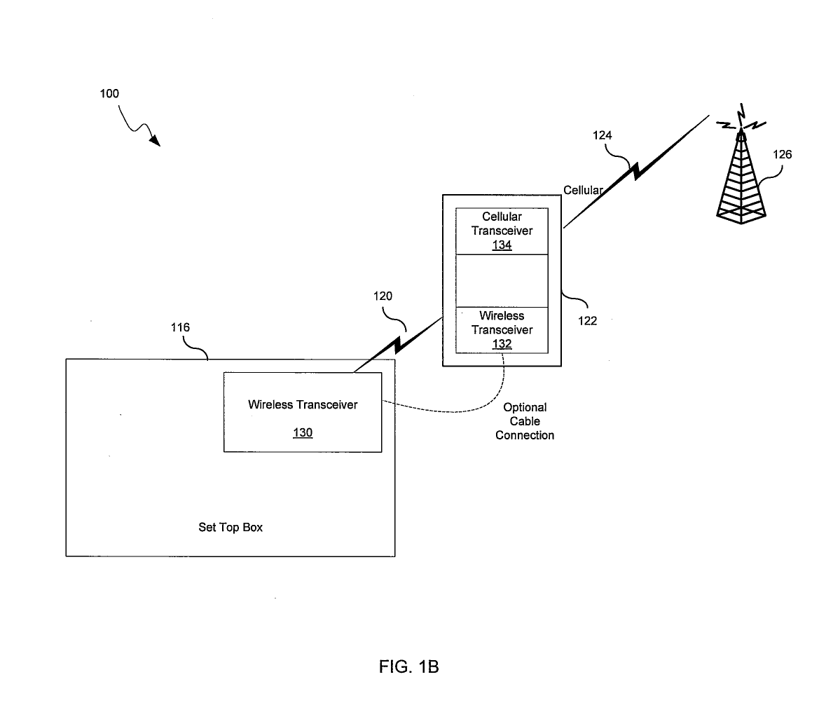

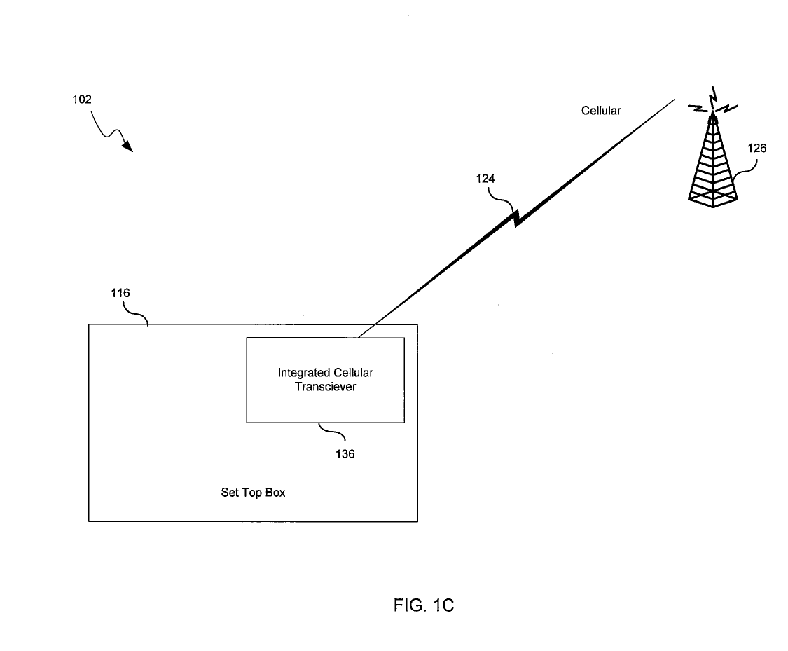

FIG. 1A is a block diagram of an exemplary communication system comprising a satellite set top box (STB) enabled to engage in DTMF digit back channel communication, in accordance with an embodiment of the invention. Referring to FIG. 1A, there is shown an exemplary communications system 100 that may comprise a communications satellite 110, a satellite signal 112, a parabolic receiving dish 114, a set top box (STB) 116, an audio/video display 118, a Bluetooth signal 120, a cellular phone 122, a cellular signal 124, a base station 126, networked entities 140, a cellular network 142, a cellular gateway 144, the internet 148, the public switched telephone network (PSTN) 150, a satellite service provider billing center 152, a server 158, and a location based services node 156.

The communications satellite 110 may be utilized to deliver television signals to consumers and/or cable television providers for example. The communications satellite 110 may receive transmissions from an uplink facility such as a satellite service provider headend via a transponder and may broadcast the satellite signal 112 to one or more terrestrial satellite dishes such as the parabolic receiving dish 114, for example.

The STB 116 may be communicatively coupled with the parabolic receiving dish 114, the audio/video display 118 and a cellular phone 122. The set top box (STB) 116 may comprise suitable logic, circuitry and/or code to receive the satellite signal 112 that may comprise audio/video data. In addition, the STB 116 may process and/or decode the audio/video data and may forward an audio/video data stream to the audio/video display 118 for example. Moreover, the STB 116 may comprise suitable logic, circuitry and or code to communicate data, for example billing data or other data, via a back channel to one or more networked entities 140. In this regard, the STB 116 may be enabled to communicate data via DTMF digits. For example, a four bit data sequence may be encoded into DTMF digits according to Table 1. The STB 116 may establish a connection with the one or more networked entities and may transmit the DTMF digits. The one or more networked entities may be a billing center located at a satellite headend for example. In an exemplary embodiment of the invention, the STB 116 may dial the server 158 over the cellular phone 122 utilizing a profile and establish the connection for transmitting the DTMF digits. The STB 116 may communicate with the cellular phone 122 via a wireless connection or a wired connection. Exemplary wireless connection may comprise IR, Bluetooth, ZigBee, WiFi and/or any suitable WLAN or WPAN connection. Exemplary wired connection may comprise USB and Ethernet.

TABLE 1

| Bit Sequence | DTMF digit |
|---|---|
| 0000 | 0 |
| 0001 | 1 |
| 0010 | 2 |
| 0011 | 3 |
| 0100 | 4 |
| 0101 | 5 |
| 0110 | 6 |
| 0111 | 7 |
| 1000 | 8 |
| 1001 | 9 |
| 1010 | A |
| 1011 | B |
| 1100 | C |
| 1101 | D |
| 1110 | * |
| 1111 | # |

The cellular phone 122 may comprise suitable logic, circuitry and or code to receive DTMF digits from the STB 116 via the Bluetooth signal 120 as well as send and receive DTMF digits via the cellular signal 124 and base station 126 to and/or from the cellular network 142. In this regard, the cellular phone 122 may establish a call via the cellular network 142. The cellular phone 122 is not limited to utilizing a specific wireless technology or frequency band and may communicate via any suitable frequency and/or wireless technology that may handle DTMF digit delivery.

The networked entities 140 may comprise a cellular network 142 that may handle traffic to and from the base station 126. The cellular network 142 may be communicatively coupled with a plurality of networked entities and/or networked services. For example, the cellular network may be communicatively coupled with the public switched telephone network (PSTN) 150 and/or to the internet 148 via the cellular gateway 144 for example. The PSTN 150 and/or the internet for example, may enable delivery of DTMF digits to other networked services such as the satellite service provider's billing center 152 and server 158 that may be located within the service provider billing center 152. In addition, DTMF digits may be delivered to the location based services node 156 for example. The networked elements within the networked entities 140 may support analog and/or digital communication. Accordingly, the generated DTMF digits sent from STB 116 may be converted to dual tone analog DTMF before or after reaching a terminating element such as the server 158 within the satellite service provider's billing center 152. Moreover, a networked entity or service within the networked entities 140 may return an acknowledgement of receipt of the DTMF digits to the STB 116. Networked entities and/or services available to send and/or receive DTMF digits to and/or from the STB 116 are not limited to those described in networked entities 140 and may comprise any networked entity and/or service or combination of services enabled to receive and handle DTMF digits from the STB 116.

In operation, the STB 116 may determine when to send DTMF digits, based on one or more of a plurality of triggers. For example, the STB may receive a request via the forward satellite signal 112, the networked entities 140, subscriber input and/or an internal periodic schedule. In this regard, the STB 116 may establish a Bluetooth connection with the cellular phone 122 via, for example, the Bluetooth signal 120. The STB 116 may encode data, for example billing data, into DTMF digits. The STB 116 may dial the server 158 within the networked entities 140 and the satellite service provider billing center 152 via the cellular phone 122 utilizing a Bluetooth profile and may establish a connection with the server 158. The STB 116 may transmit the DTMF digits via the Bluetooth signal 120 to the cellular phone 122. The cellular phone 122 may forward the received DTMF digits to the cellular network 142 via the cellular signal 124 and base station 126. The cellular network may forward the DTMF digits to the server 158 within satellite service provider billing center 152 via the cellular gateway 144 and a data network or via the PSTN 150. In addition, the server 158 within the satellite service provider billing center 152 may send an analog and/or digital acknowledgement of receipt of DTMF digits back to the STB 116 and the STB 116 may receive the acknowledgement of receipt of DTMF digits. In some embodiments of the invention, the destination networked entity 140 such as the server 158 within satellite service provider billing center 152 may be enabled to handle DTMF tones. In this regard, at some point within the back channel communication path, for example, within the PSTN 150, the generated DTMF digits may be converted to analog tones and vice versa.

FIG. 1B is a block diagram of an exemplary STB enabled to communicate DTMF digits to networked entities via an integrated Bluetooth transceiver and a cellular phone, in accordance with an embodiment of the invention. Referring to FIG. 1B, there is shown a portion of the system 100 from FIG. 1A comprising a set top box (STB) 116, a wireless transceiver 130, a wireless signal 120, a cellular phone 122, a wireless transceiver 132, a cellular transceiver 134, a cellular signal 124 and a base station 126.

The STB 116, cellular phone 122, cellular signal 124 and base station 126 may be similar to or substantially the same as the respective figure elements shown in FIG. 1A.

The STB 116 may comprise one or more integrated transceivers such as the wireless transceiver 130. In accordance with an embodiment of the invention, the wireless transceiver 130 may be enabled to transmit and/or receive signals such as DTMF digits via the wireless signal 120 to one or more wireless devices such as the cellular phone 122 comprising the wireless transceiver 132. The invention is not limited in regard to type of transceiver utilized to convey DTMF digits. For example the wireless transceivers 130 and 132 may be Bluetooth, Zigbee, wireless local area network (WLAN), cellular and/or infrared (IR) and may be utilized to convey data such as DTMF digits. In instances where the wireless transceivers 130 and/or 132 are Bluetooth, the corresponding wireless signal 120 may be a Bluetooth signal. In instances where the wireless transceivers 130 and/or 132 are Zigbee, the corresponding wireless signal 120 may be a Zigbee signal. In instances where the wireless transceivers 130 and/or 132 are WLAN, the corresponding wireless signal 120 may be a WLAN signal. In instances where the wireless transceivers 130 and/or 132 are cellular, the corresponding wireless signal 120 may be a cellular signal. In instances where the wireless transceivers 130 and/or 132 are IR, the corresponding wireless signal 120 may be an IR signal. In addition, a cable such as a USB cable may be connected between the cellular phone 122 and the STB 116 to convey signals comprising, for example, DTMF digits.

The cellular phone 122 may comprise a plurality of wireless transceivers for example, a wireless transceiver 132 and a cellular transceiver 134. In this regard, the cellular phone 122 may be enabled to transmit and receive data such as DTMF digits to and/or from the STB 116 as well as sending and/or receiving DTMF digits via the cellular transceiver 134 and cellular signal 124 to the base station 126.

In operation, the STB 116 may establish a wireless connection with the cellular phone 122. The STB 116 may encode data, for example billing data, into DTMF digits. The STB 116 may dial a modem within the networked entities block 140, for example, the server 158 within the satellite service provider billing center 152 shown in FIG. 1A. The STB 116 may communicate the DTMF digits to the cellular phone 122 via the wireless transceiver 130, the wireless signal 120 and the wireless transceiver 132. The cellular phone 122 may forward the received the DTMF digits to the cellular base station 126 via the cellular transceiver 134 and cellular signal 124. In addition, the STB 116 may receive a plurality of back channel communication via the wireless transceiver 130 that may comprise for example acknowledgement of receipt of DTMF digits, replies to messages sent from the STB 116, and/or other messages from networked entities 140. For example, the server 158 may send a 2100 Hz tone to acknowledge receipt of the DTMF digits. Moreover, requests for data, coded instructions and/or application data may be received by the STB 116 via the back channel.

FIG. 1C is a block diagram of an exemplary STB enabled to communicate DTMF digits via an integrated cellular transceiver, in accordance with an embodiment of the invention. Referring to FIG. 1C, there is shown a system 102 comprising a set top box (STB) 116, an integrated cellular transceiver 136, a cellular signal 124 and a base station 126.

The STB 116, cellular signal 124 and base station 126 may be similar or substantially the same as the respective figure elements shown in FIGS. 1A and 1B.

The STB 116 integrated cellular transceiver 136 may comprise suitable logic, circuitry and or code to generate, send and/or receive DTMF digits to and/or from the cellular base station 126 and/or the networked entities 140 described in FIG. 1A for example. In this regard, an intermediate communication device such as the cellular phone 122 comprising a Bluetooth transceiver 130 described in FIGS. 1A and 1B may not be needed. The integrated cellular transceiver 136 may communicate directly with the base station 126 via any suitable frequency and/or wireless technology that may handle DTMF digits.

The STB 116 may encode data into one or more DTMF digits and may dial a modem within the networked entities 140, for example, the server 158 within the satellite service provider billing center 152 shown in FIG. 1A. The STB 116 may send the DTMF digits to the cellular phone 122 via the Bluetooth transceiver 130, the Bluetooth signal 120 and the Bluetooth transceiver 132.

In operation, the STB 116 may encode data into one or more DTMF digits destined for one or more of the networked entities 140 described in FIG. 1A. The STB 116 may dial a modem within the networked entities 140, for example, the server 158 within the satellite service provider billing center 152 shown in FIG. 1A via the integrated cellular transceiver 136. The STB 116 may transmit the DTMF digits to the cellular base station 126 via the cellular transceiver 136 and the cellular signal 124. In addition, the STB 116 may receive data via the cellular transceiver 136 that may comprise for example acknowledgement of receipt of DTMF digits, replies to messages sent from the STB 116, and/or other messages from networked entities 140. For example, requests for data, coded instructions and/or application data may be received via the back channel.

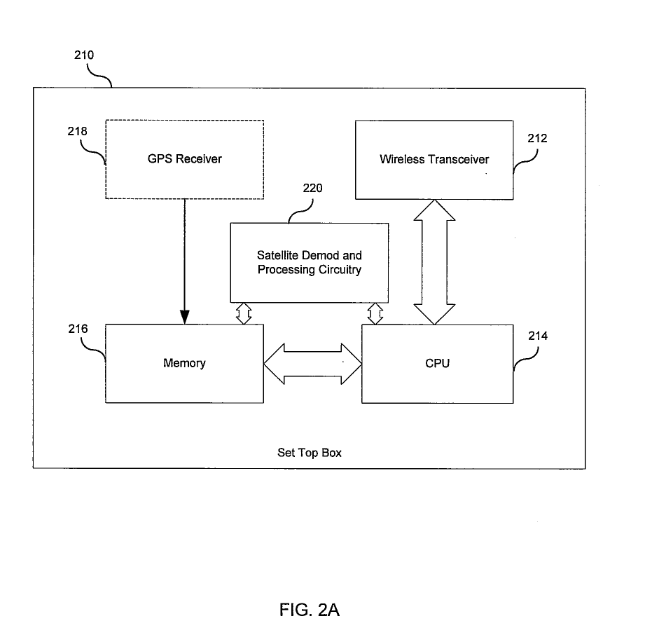

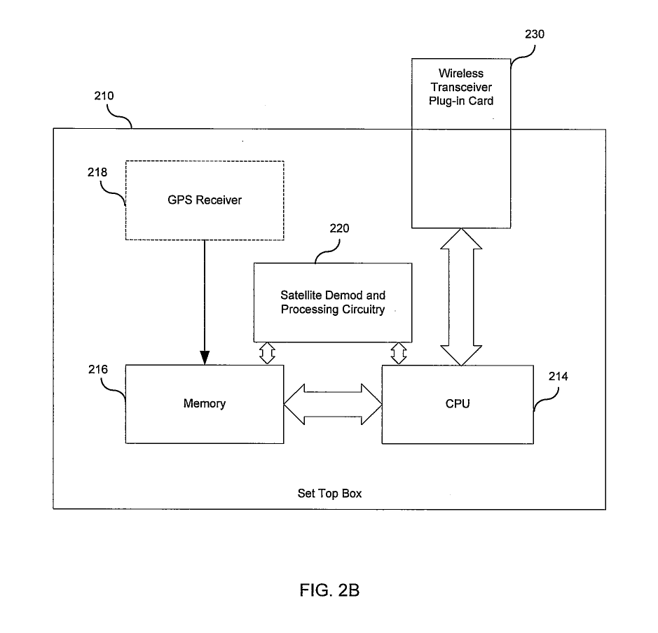

FIG. 2A is a block diagram of an exemplary back channel portion of an STB configured to transmit DTMF digits via an integrated wireless transceiver, in accordance with an embodiment of the invention. Referring to FIG. 2A, there is shown a set top box (STB) 210 that may comprise a wireless transceiver 212, a CPU 214, a memory 216, an optional GPS receiver 218 and a satellite demodulation and signal processing circuit 220.

The set top box (STB) 210 may be similar and/or substantially the same as the STB 116 described in FIGS. 1A, 1B and/or 1C. The STB 210 may be enabled to communicate via DTMF digits for example to and/or from one or more networked entities 140 via one or more wireless transceivers such as the wireless transceiver 212. The STB 210 may be enabled to encode and/or decode data, for example DTMF digits within the CPU 214. The DTMF digits may comprise billing and/or other data. In some embodiments of the invention, the STB 210 may comprise a global positioning (GPS) receiver and may communicate location data via back channel DTMF digits with one or more networked entities 140. Moreover, security operations for the STP 116 may be enabled via back channel DTMF digit communication.

The wireless transceiver 212 may comprise suitable logic, circuitry and/or code to enable communication of data such as DTMF digits to and/or from one or more networked entities 140. The wireless transceiver 212 may be integrated within the STB 210. The wireless transceiver 212 may comprise any suitable wireless technology and may utilize any suitable frequency for transmission and/or reception of wireless signals. For example, the wireless transceiver may enable wireless and/or cabled personal area network (WPAN and/or PAN) communications such as Bluetooth, wireless local area network (WLAN) communications and/or wide area network communications such as cellular communications. In some embodiments of the invention, the STB 210 may be enabled to connect to an intermediary wireless device such as a cellular phone via a cable such as a USB cable for example. The wireless transceiver 212 may be enabled to communicate directly with a base station or may communicate with a base station via an intermediary device such as the cellular phone 122 shown in FIGS. 1A and 1B. In this regard, the cellular phone and STB 210 may communicate via a WPAN or Bluetooth connection for example.

The CPU 214 may comprise suitable logic, circuitry and or code to establish, monitor and/or control sending and/or receiving data such as DTMF digits to one or more networked entities 140 such as with the server 158 within the satellite service provider billing center 152 described in FIG. 1A. In this regard, the CPU 214 may run a driver for the wireless transceiver device 212. For example, a firmware driver for a Bluetooth transceiver may run on the CPU 214. In addition, software applications for establishing, monitoring and/or controlling the transfer of data such DTMF digits may run on the CPU 214.

The memory 216 may comprise suitable logic, circuitry and/or code to enable sending and/or receiving data such as DTMF digits to and/or from one or more networked entities 140 such as with the server 158 within the satellite service provider billing center 152 described in FIG. 1A. Accordingly, the memory 216 may store instructions and or data utilized and/or generated by the CPU 214. For example, the memory 216 may enable storage of calling data for DTMF digits instructions and/or processing data. Furthermore, the memory 216 may enable storage of service provider and/or subscriber data such as data based on billing and/or service requests.

The optional GPS receiver 218 may comprise suitable logic, circuitry and/or code that may be enabled to receive GPS data from one or more GPS satellites and may be enabled to determine the device 210's position from the received GPS data. For example the GPS receiver 218 may determine device 210's position based on ephemeris, signal delay and satellite position. Moreover, other sources of location or timing data may be utilized to determine the location of the device. For example, user input or input from another position or time referencing system may be utilized. In some embodiments of the invention, location data may be sent to one or more networked entities such as the location based services 156 described in FIG. 1A, via back channel communication such as DTMF digits. In this regard, the STB 210 determined location and/or timing data may be sent. Furthermore, raw data such as data received from GPS satellites and/or GPS signal measurements taken by the STB 210 may be sent to, for example, the location based services 156 and the location based services 156 may determine the location of the STB 210.

The satellite demodulation and signal processing circuit 220 may comprise suitable logic, circuitry and/or code to receive and process video signals from the communications satellite 110 via the parabolic receiving dish 114. In this regard, the video signal processing may comprise descrambling, decoding and/or various security operations for example. Received and processed video signals may be forwarded to the audio/video display 118.

In operation, the STB 210 may receive a request for transmission of data from an external entity such as the satellite service provider billing center 152 and/or a subscriber for example. In some embodiments of the invention, the STB 210 may determine when to transmit data based on instructions and/or data stored within the memory 216 for example. Accordingly, the STB 210 may encode the data with DTMF digits for back channel communication within the CPU 214 based on instructions and parameters from the memory 216. In some embodiments of the invention, the STB 210 may establish a wireless connection such as a Bluetooth connection via the wireless transceiver 212. The STB 210 may dial the server 158 within the satellite service provider billing center 152 for example, via the cellular phone 122 utilizing a Bluetooth profile stored in the memory 216 and may establish a phone call with the server 158. In other embodiments of the invention, the wireless transceiver 212 may be, for example, a cellular transceiver and may dial the server 158 within the satellite service provider billing center 152 for example, via a cellular base station. In addition, the STB 210 may receive one or more acknowledgements of receipt from one or more recipients of the transmitted back channel DTMF digits. Moreover, the STB 210 may receive back channel communication from, for example, the server 158 within the billing center 152. The STB 210 may decode the received back channel communication within the CPU 214 and store it within the memory 216 for example.

FIG. 2B is a block diagram of an exemplary back channel portion of an STB configured to transmit DTMF digits via a wireless transceiver plug-in card, in accordance with an embodiment of the invention. Referring to FIG. 2B there is shown a set top box (STB) 210 a wireless transceiver plug-in card 230, a CPU 214, a memory 216, an optional GPS receiver 218 and a satellite demodulation and signal processing circuit 220.

The STB 210, CPU 214, memory 216, optional GPS receiver 218 and satellite demodulation and signal processing circuit 220 may be similar or substantially the same as the respective blocks shown in FIG. 2A.

The wireless transceiver plug-in card 230 may comprise suitable logic, circuitry and/or code to enable communication of data such as DTMF digits to and/or from one or more networked entities 140. The wireless transceiver plug-in card 230 may be attached or detached to the STB 210 by a user. The wireless transceiver plug-in card 230 may comprise any suitable wireless technology such as Bluetooth, Zigbee, wireless local area network (WLAN), infrared (IR) or cellular for example. In addition, the wireless transceiver plug-in card 230 may utilize any suitable frequency for transmission of wireless signals comprising DTMF digits. The wireless transceiver plug-in card 230 may be enabled to communicate directly with a base station or may communicate with a base station via an intermediary device such as a cellular phone. In this regard, the cellular phone and STB 210 may communicate via a WPAN or Bluetooth connection for example.

In operation, the STB 210 may receive a request for transmission of data from a networked 140 entity such as the satellite service provider billing center 152 and/or a subscriber for example. In some embodiments of the invention, the STB 210 may determine to transmit the data via the back channel based on received instructions and/or data stored within memory 216, for example. Accordingly, the STB 210 may encode the data with DTMF digits comprising a destination address to, for example, the server 158 within the satellite service provider billing center 152 described in FIG. 1A. The STB 210 may establish a wireless connection such as a cellular connection via the wireless transceiver plug-in card 230 and may transmit the DTMF digits via the wireless transceiver plug-in card 230. In addition, the STB 210 may receive one or more acknowledgements of receipt from one or more recipients of the transmitted DTMF digits via the plug-in card 230.

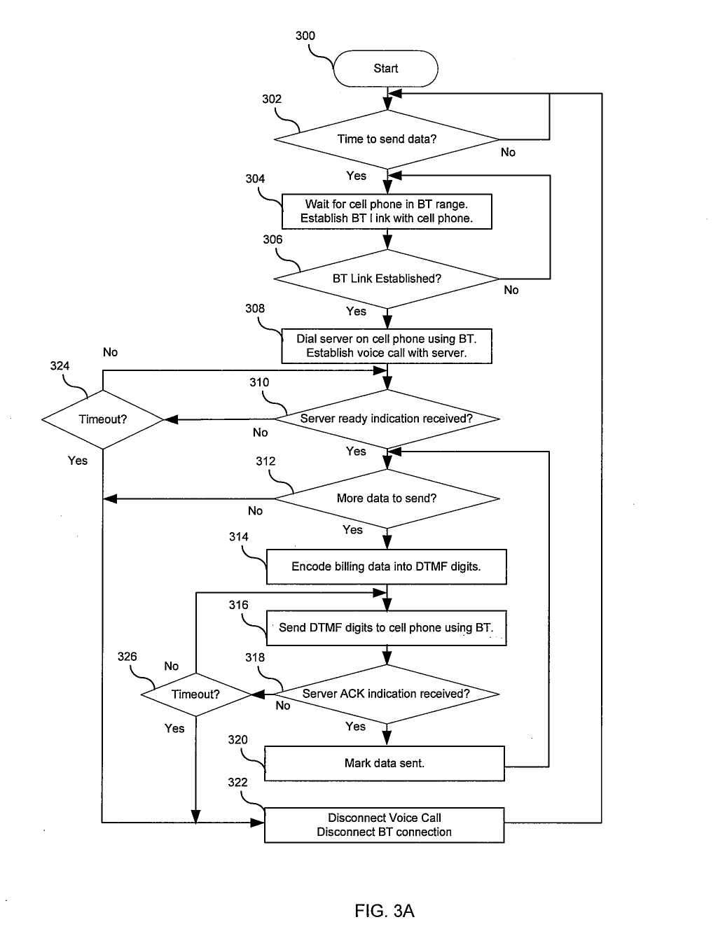

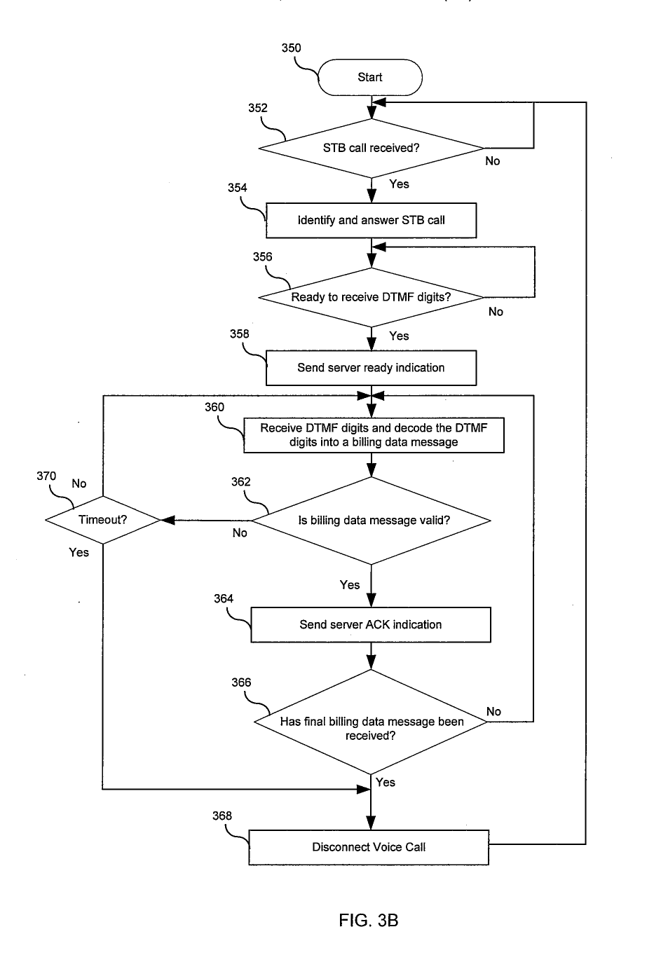

FIG. 3A is a flow chart illustrating exemplary steps for utilizing DTMF digits for STB communication with networked entities, in accordance with an embodiment of the invention. Referring to FIG. 3A, after start step 300, in step 302, the STB 116 or 210 may determine whether data may be available for communicating, for example, the STB may wait for a request for billing data from the server 158. A request may be received via a forward channel, back channel or an internal request may be generated for example. If the STB 116 or 210 determines that the billing data may be available for communicating, the exemplary steps may proceed to step 304. In step 304, the STB 116 or 210 may wait for availability of a Bluetooth (BT) link and may establish a BT connection with a cellular phone 122 for example. For example, the cellular phone 122 may need to be positioned within range for a Bluetooth connection. In step 306, if the BT link is established, the exemplary steps may proceed to step 308. In step 308, the STB 116 or 210 may dial the server 158 within the satellite service provider billing center 152, for example, and may establish a voice call. In step 310, the STB may wait for a ready indication from the server 158 which may be an 1100 Hz tone for example. If the ready indication is received by the STB 116 or 210, the exemplary steps may proceed to step 312. In step 312, the STB 116 or 210 may determine if there is more data to send. If there is more data to send, the exemplary steps may proceed to step 314. In step 314, the data such as billing data may be encoded into DTMF digits. In step 316, the STB 116 or 210 may utilize BT to send the DTMF digits to the cellular phone 122 and to the server 158 within the satellite service provider billing center 152. For example, the STB 116 or 210 may utilize a Bluetooth AT command interface and/or an AT command such as “AT+VTS”. In step 318, the STB may wait to receive an acknowledgement indication (ACK) from the server 158 within the satellite service provider billing center 152 such as a 2100 Hz tone for example. If the ACK is received, the exemplary steps may proceed to step 320. In step 320, the STB may indicate that the data has been sent and may proceed to step 312.

In step 302, if the STB 116 or 210 does not determine that data may be available for communication, the exemplary steps may proceed to step 302 and may continue to determine whether data may be available for communication. In step 306, if a BT link is not established, the exemplary steps may proceed to step 304. In step 310, if the ready indication is not received by the STB 116 or 210, the exemplary steps may proceed to step 324. In step 324, if the STB 116 or 210 times out, the exemplary steps may proceed to step 322. In step 324, if the STB 116 or 210 does not timeout, the exemplary steps may proceed to step 310. In step 324 if the STB 116 or 210 times out, the exemplary steps may proceed to step 322. In step 312, if there is no more data to send, the exemplary steps may proceed to step 322. In step 318, if an ACK is not received, the exemplary steps may proceed to step 326. In step 326, the STB 116 or 210 may determine if a time out has occurred. If no time out has occurred, the exemplary steps may proceed to step 322. In step 326, if the process has timed out, the exemplary steps may proceed to step 316.

FIG. 3B is a flow chart illustrating exemplary steps for utilizing DTMF digits for STB communication with networked entities from the perspective of a server that may be located within a satellite service provider billing center, in accordance with an embodiment of the invention. Referring to FIG. 3B, after start step 350, in step 352, the server 158 that may be located within the satellite service provider billing center 152 may determine if a call has been received from the STB 116 or 210. The call may be in response to a request from the server 158 or may be self generated by the STB 116 or 210. If the call has been received, the exemplary steps may proceed to step 354. In step 354, the server 158 may identify the STB 116 or 210 through caller ID of a registered cellular phone number for example and may answer the phone call. In step 356, the server 158 may determine if it is ready to receive DTMF digits. If the server 158 is ready to receive the DTMF digits, the exemplary steps may proceed to step 358. In step 358, the server 158 may send the STB 116 or 210 a ready to receive indication. In step 360, the server 158 may receive DTMF digits and decode them into a billing data message from STB. In step 362, the server 158 may review received billing data message. If the received billing data message is valid, the exemplary steps may proceed to step 364. In step 364, the server 158 may send an acknowledgement (ACK) indication to the STB 116 or 210. In step 366, the server 158 may review the received billing data message to determine if a final billing data message has been received. If the final billing data message has been received, the exemplary steps may proceed to step 368. In step 368, the server 158 may disconnect the voice call and the exemplary steps may proceed to step 352.

In step 352, if the call has not been received, the exemplary steps may proceed to step 352. In step 356, if the server 158 is not ready to receive the DTMF digits, the exemplary steps may proceed to step 356. In step 362, if the billing data message is not valid, the exemplary steps may proceed to step 370. In step 370 if a time out has occurred, the exemplary steps may proceed to step 368. In step 370, if no time out has occurred, the exemplary steps may proceed to step 360. In step 366, if the final billing data message has not been received, the exemplary steps may proceed to step 360.

In an embodiment of the invention, data may be encoded into a plurality of dual tone multiple frequency (DTMF) digits within the set top box (STB) 116 and/or 210. The STB 116 and/or 210 may establish a back channel to a networked entity 140 such as a satellite service provider headend and/or satellite service provider billing center 152 shown in FIG. 1A. The STB 116 and/or 210 may communicate the plurality of DTMF digits to the networked entity 140. The wireless transceiver 212 integrated within the STB 116 and/or 210 and/or an external wireless transceiver may be utilized to establish a call and transmit the DTMF digits. The external wireless transceiver may be coupled to the STB via a wired connection. In some embodiments of the invention, the integrated and/or external transceiver may be the Bluetooth transceiver 130 shown in FIG. 1B. The Bluetooth transceiver, 130 may be utilized to establish the call to the networked entity 140 and to transmit the DTMF digits via the external cellular phone 122. In addition, the STB 116 and/or 210 may receive an acknowledgement indication corresponding to the transmitted DTMF digits via the integrated and/or external wireless transceiver. The STB may be a satellite STB and/or the communicated DTMF digits may comprise billing data. The networked entity may comprise a satellite headend.

Certain embodiments of the invention may comprise a machine-readable storage having stored thereon, a computer program having at least one code section for back channel communication utilizing DTMF for set top box devices, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an data processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for set top box communication, the method comprising:
encoding data into a plurality of dual tone multiple frequency (DTMF) digits within a set top box (STB);
establishing a back channel between said STB and a networked entity; and
communicating said plurality of DTMF digits from said STB to said networked entity via said established back channel.

2. The method according to claim 1, wherein said data comprises billing data.

3. The method according to claim 1, comprising establishing voice call with said networked entity via an integrated and/or external wireless transceiver.

4. The method according to claim 3, wherein said external wireless transceiver is coupled to said STB via a wired connection.

5. The method according to claim 3, comprising transmitting said plurality of DTMF digits via said integrated and/or external wireless transceiver.

6. The method according to claim 5, wherein said integrated and/or external wireless transceiver is a Bluetooth transceiver utilized to establish said phone call with said networked entity via an external cellular phone.

7. The method according to claim 6, comprising transmitting said plurality of DTMF digits via said integrated Bluetooth transceiver and said external cellular phone.

8. The method according to claim 5, comprising receiving one or more acknowledgements of receipt for said transmitted plurality of DTMF digits via said integrated and/or external wireless transceiver.

9. The method according to claim 1, wherein said STB is a satellite STB.

10. The method according to claim 1, wherein said networked entity comprises a satellite headend.

11. A system for set top box communication, the system comprising:
one or more circuits that enable encoding data into a plurality of dual tone multiple frequency (DTMF) digits within a set top box (STB);
said one or more circuits enables establishment of a back channel between said STB and a networked entity; and
said one or more circuits enables communication of said plurality of DTMF digits from said STB to said networked entity via said established back channel.

12. The system according to claim 11, wherein said data comprises billing data.

13. The system according to claim 11, wherein said one or more circuits enables establishment of a voice call with said networked entity via an integrated and/or external wireless transceiver.

14. The system according to claim 13, wherein said external wireless transceiver is coupled to said STB via a wired connection.

15. The system according to claim 13, wherein said one or more circuits enables transmission of said plurality of DTMF digits via said integrated and/or external wireless transceiver.

16. The system according to claim 15, wherein said integrated and/or external wireless transceiver is a Bluetooth transceiver utilized to establish said phone call with said networked entity via an external cellular phone.

17. The system according to claim 16, wherein said one or more circuits enables transmission of said plurality of DTMF digits via said integrated Bluetooth transceiver and said external cellular phone.

18. The system according to claim 15, wherein said one or more circuits enables reception of one or more acknowledgements of receipt for said transmitted plurality of DTMF digits via said integrated and/or external wireless transceiver.

19. The system according to claim 11, wherein said STB is a satellite STB.

20. The system according to claim 11, wherein said networked entity comprises a satellite headend.

21. A machine-readable storage having stored thereon, a computer program having at least one code section for set top box communication, the at least one code section being executable by a machine for causing the machine to perform steps comprising:
encoding data into a plurality of dual tone multiple frequency (DTMF) digits within a set top box (STB);
establishing a back channel between said STB and a networked entity; and
communicating said plurality of DTMF digits from said STB to said networked entity via said established back channel.

22. The machine-readable storage according to claim 21, wherein said data comprises billing data.

23. The machine-readable storage according to claim 21, wherein said at least one code section comprises code that enables establishing a voice call with and communicating said plurality of DTMF digits to said networked entity via an integrated and/or external wireless transceiver.

24. The machine-readable storage according to claim 24, wherein said integrated and/or external wireless transceiver is a Bluetooth transceiver utilized to establish said phone call with said networked entity and transmit said plurality of DTMF digits via an external cellular phone.

25. The machine-readable storage according to claim 21, wherein said networked entity comprises a satellite headend.
